(19) United States
(12) Patent Application Publication
(10) Pub. No.: US 2010/0277081 A1
(43) Pub. Date: Nov. 4, 2010

(54) CLOCK BRIGHTNESS CONTROL CIRCUIT

(75) Inventor: QIXIANG FENG, SHENZHEN (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SHENZHEN GREAT POWER ENTERPRISE CO., LIMITED, SHENZHEN (CN)

(21) Appl. No.: 12/432,755

(22) Filed: Apr. 30, 2009

(51) Int. Cl. H05B 37/02

(52) U.S. Cl. 315/158; 368/239

(57) ABSTRACT

A clock brightness control circuit includes at least a photosensitive element connected with a current limiting element and a current regulating element. The current limiting element and the current regulating element are connected with a light-emitting element of a clock, and adjust a current flowing through the light-emitting element under control of the photosensitive element in response to ambient light illumination. The clock brightness control circuit can adjust the brightness of the clock upon a change of the ambient light illumination when the circuit is applied in the clock.

### BACKGROUND OF THE INVENTION

The present invention relates to a clock brightness control circuit using DC power, and more particularly to a clock brightness control circuit used to adjust the brightness of a clock upon a change of ambient light illumination.

Nowadays, a digital clock using DC power is widely used in offices, families and public places. Such digital clock can provide direct, accurate and bright time indication to viewers, thereby bringing great convenience to people's life. However, as well known, the brightness of the current digital clock is constant, i.e. the brightness will not change regardless of ambient light illumination. Therefore, the current digital clock suffers from following drawbacks: 1. In a bright environment, there is a need for a high-brightness display of the clock to form a contrast against ambient light in order for easily reading the time indication on the clock. However, in a dim environment or at night, the high-brightness display looks very dazzling. In contrast, if a clock with constant brightness can provide a normal display for viewers in a dim environment, the display cannot be easily read in a bright environment. 2. Such clock with constant brightness consumes same power regardless of the ambient light illumination, which causes not only energy waste but also inconvenience to users in some cases.

### SUMMARY OF THE INVENTION

The present invention provides a clock brightness control circuit which can adjust the brightness of a clock upon a change of ambient light illumination.

In accordance with a first aspect of the present invention, a clock brightness control circuit includes a current limiting element, a current regulating element, and at least one photosensitive element connected with the current limiting element and the current regulating element. The current limiting element and the current regulating element are connected with a light-emitting element of a clock and adjust a current flowing through the light-emitting element under control of the photosensitive element in response to ambient light illumination.

In an embodiment of the clock brightness control circuit, the photosensitive element is a photosensor comprising an element having a viable resistance in response to the ambient light illumination.

In an embodiment of the clock brightness control circuit, the photosensor includes a photosensitive resistor or a photosensitive diode.

In an embodiment of the clock brightness control circuit, the current limiting element includes a first resistor and a second resistor connected in series with the first resistor, and having a first end connected with the first resistor at a first node and a second end connected with the light-emitting element at a second node.

In an embodiment of the clock brightness control circuit, the current regulating element includes a transistor having a base, a collector and an emitter. The collector is connected with the first node, the emitter is connected with the second node, and the photosensitive element is connected between the collector and the base.

In an embodiment of the clock brightness control circuit, the photosensitive element includes a photosensitive resistor and a third resistor connected in series with the photosensitive resistor.

In an embodiment of the clock brightness control circuit, the light-emitting element includes a light-emitting diode.

In accordance with a second aspect of the present invention, a clock brightness control circuit for adjusting a current flowing through a light-emitting element of a clock includes a first resistor, a second resistor connected in series with the first resistor and having a first end connected with the first resistor at a first node and a second end connected with the light-emitting element at a second node, a transistor having a base, a collector and an emitter, and a photosensitive element. The collector is connected with the first node, the emitter is connected with the second node, and the photosensitive element is connected between the collector and the base.

In an embodiment of the clock brightness control circuit, the photosensitive element includes a photosensitive resistor and a third resistor connected in series with the photosensitive resistor.

The advantage of the present invention lies in that the brightness of the clock is adjustable depending on the intensity of ambient light, therefore it has significant energy saving effect and provides good display adapted to different ambient light illuminations. The circuit can adjust the brightness of the clock when the ambient light illumination changes. In daytime or a bright environment, the clock can provide a relatively bright display; while at night or in a dim environment, the clock can provide a relatively dim display, so that it is adapted to the visual perception of human eyes in different conditions. Since the brightness of the clock is variable in different light illuminations, it helps to save the energy and prolong the working life of elements in the clock. Moreover, the present invention is simple in circuit, low in cost and is easy to implement.

### BRIEF DESCRIPTION OF THE FIGURES

The accompanying figures are included to provide a further understanding of the present inventive concept, and are incorporated in and constitute a part of this specification. The drawings illustrate exemplary embodiments of the present inventive concept and, together with the description, serve to explain principles of the present inventive concept.

FIG. 1 is a schematic block diagram of a clock brightness control circuit according to the present invention.

FIG. 2 is a schematic circuit diagram of a clock brightness control circuit according to the present invention.

FIG. 3A shows a display interface of LED-type digital clock according to the present invention.

FIG. 3B is a schematic circuit diagram of the LED-type digital clock shown in FIG. 3A according to one embodiment of the present invention.

FIG. 3C is a schematic circuit diagram of the LED-type digital clock shown in FIG. 3A according to another embodiment of the present invention.

FIG. 4 shows a display interface of a LCD-type digital clock according to the present invention.

FIG. 5 shows a display interface of a pointer-type clock applying a clock brightness control circuit according to the present invention.

### DETAILED DESCRIPTION OF PREFERRED EMBODIMENTS

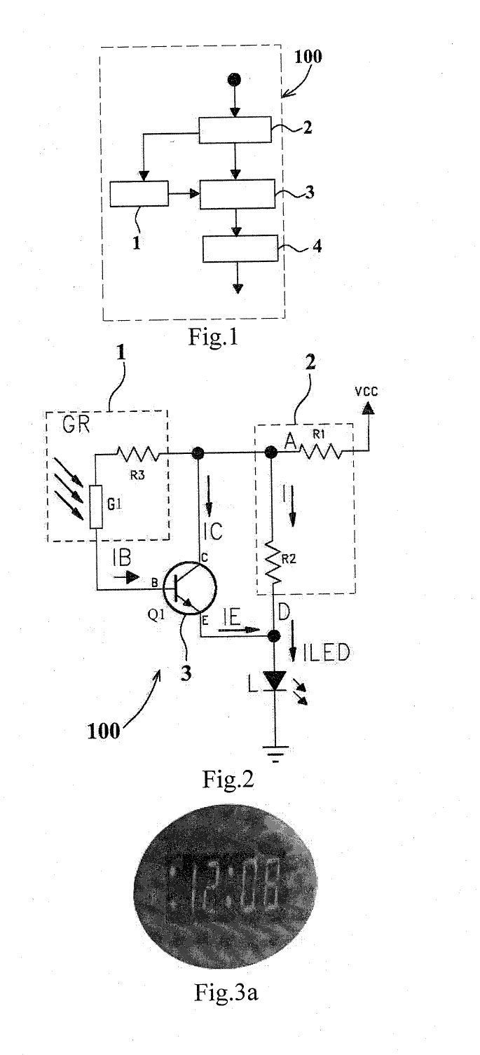

Referring to FIG. 1 and FIG. 2, the clock brightness control circuit 100 according to the present invention includes a photosensitive element 1, a current limiting element 2, a current regulating element 3 and a light-emitting element 4. Specifically, in this embodiment, the current limiting element 2 includes a first resistor R1 and a second resistor R2 connected in series with the first resistor R1. One end of the second resistor R2 is connected with the first resistor R1 at a first node A, and the other end of the second resistor R2 is connected with the light-emitting element 4 at a second node D. In this embodiment, the light-emitting element 4 is a light emitting diode L. The first resistor R1 is used for adjusting the darkness threshold of the light emitting diode L to prevent the display of the clock from being too dark to be read in a dim environment or at night. The second resistor R2 is used for adjusting the bright threshold to prevent the display of the clock from being too bright. The current regulating element 3 includes a transistor Q1 having a base B, a collector C and an emitter E. The photosensitive element 1 is a photosensor GR which can include a photosensitive resistor, a photosensitive diode or a similar element having a resistance which can be variable in response to ambient light illumination. In this embodiment, the photosensor GR includes a photosensitive resistor G1 and a third resistor R3 connected in series with the photosensitive resistor G1. The collector C of the transistor Q1 is connected with the first node A. The emitter E is connected with the second node D. That is, the second resistor R2 is connected between the collector C and the emitter E of the transistor Q1. The photosensitive element 1 is connected between the collector C and the base B of the transistor Q1.

In the clock brightness control circuit 100 shown in FIG. 1 and FIG. 2, when the ambient light illumination changes, the resistance of the photosensor GR changes, thereby changing the output current IB. When this occurs, the current IE regulated by the transistor Q1 changes accordingly and leads to a change of the current I_{LED} flowing through the light emitting diode L. Thus, the brightness of the light emitting diode L is changed upon the change of the ambient light illumination. Specifically, in a bright environment, the resistance of the photosensor GR decreases, the current IB and the current IE both increase, and the current of the light emitting diode L increases accordingly, thereby the light emitting diode L brightens. However, in a dim environment, the resistance of the photosensor GR increases, the current IB and the current IE both decrease, and the current of the light emitting diode L decreases accordingly, thereby light emitting diode L darkens.

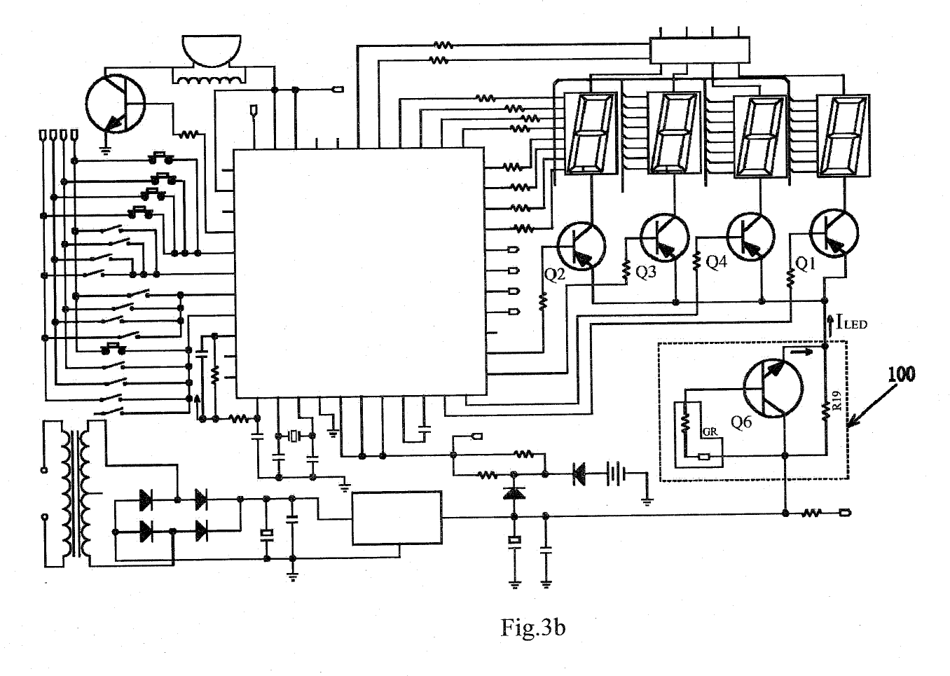

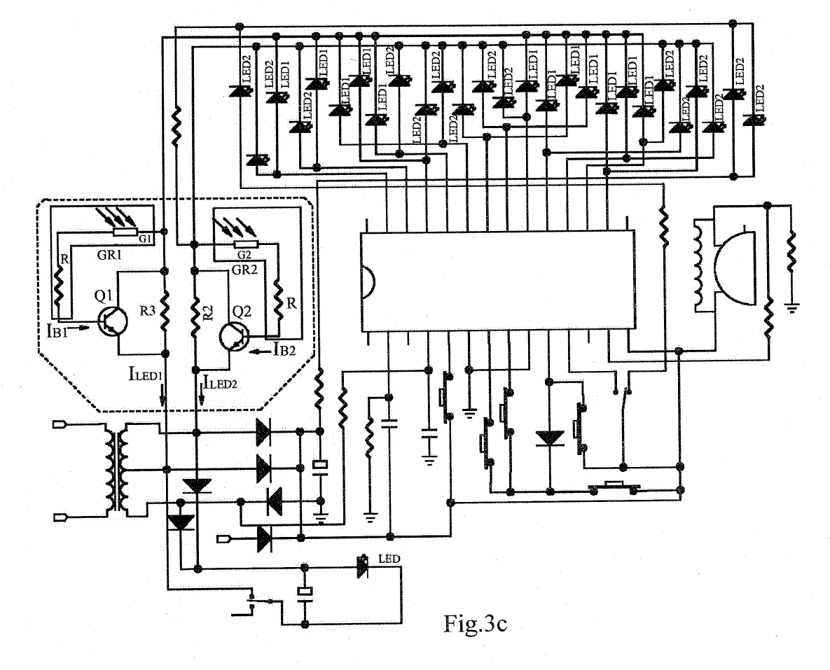

FIGS. 3A-3C show a LED-type digital clock according to the present invention. As shown in FIG. 3B, the clock brightness control circuit 100 according to the present invention is connected in series between a power supply and emitters of transistors Q1˜Q4 of a LED circuit in the LED-type digital clock to serve as a light-controlled adjustable current source. When the ambient light illumination changes, the clock brightness control circuit 100 regulates the currents of the transistors Q1˜Q4, thereby controlling the brightness of four digital LED displays. In a bright environment, the resistance of the photosensor GR decreases, and the base potential of the transistor Q6 increases. When this occurs, the current IB increases, the current IE increases accordingly, thus the emitter currents of the transistors Q1˜Q4 increases, thereby the brightness of the LED displays is increased. In a dim environment, the resistance of the photosensor GR increases, and the base potential of the transistor Q6 decreases. When this occurs, the current IB decreases, the current IE decreases accordingly, then the emitter currents of the transistors Q1˜Q4 decreases, thereby the brightness of the LED displays is decreased. The display interface of the LED-type digital clock is shown in FIG. 3A.

In an embodiment shown in FIG. 3C, the clock backlight control circuit 1 00 according to the present invention is connected in series between a negative terminal of a LED circuit in the LED-type digital clock and an AC terminal of a low-voltage power supply to serve as a light-controlled adjustable current source. A first control circuit includes a photosensor GR1, a transistor Q1 and a resistor R3. A second control circuit includes a photosensor GR2, transistor Q2 and a resistor R2. The first and second control circuits are used to control the currents I_{LED2}, I_{LED2} of the light emitting diodes LED1 and LED2, respectively. In a bright environment, the resistances of the photosensors GR1 and GR2 decrease, and the base potentials of the transistors Q1 and Q2 increase. When this occurs, the currents IB1 and IB1 increase, the currents I_{LED1} and I_{LED2} increase accordingly, thereby the brightness of the light emitting diodes LED1 and LED2 is increased. In a dim environment, the resistances of the photosensors GR1 and GR2 increase and the base potentials of transistors Q1 and Q2 decrease. When this occurs, the currents IB1 and IB1 decrease, the current I_{LED1} and I_{LED2} decrease accordingly, thereby the brightness of the light emitting diodes LED1 and LED2 is decreased.

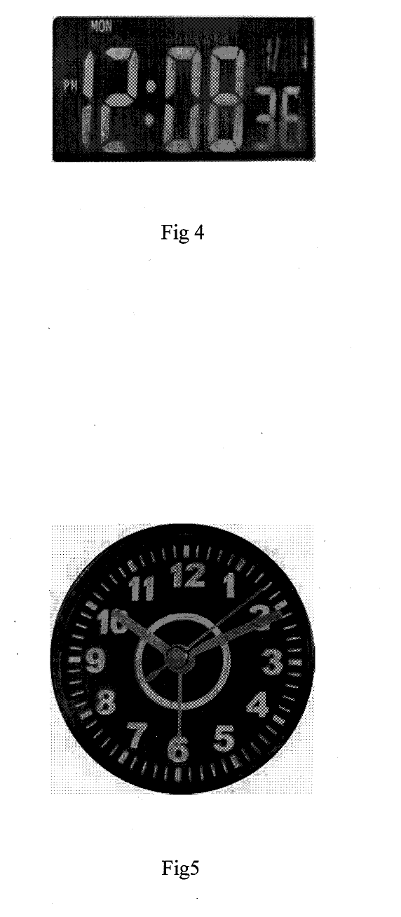

FIG. 4 shows a display interface of a LCD-type digital clock applying a clock brightness control circuit according to the present invention. In this embodiment, the clock brightness control circuit 100 shown in FIG. 1 and FIG. 2 can be used to control light emitting diodes or other light sources disposed in the backlight of the LCD-type digital clock.

FIG. 5 shows a display interface of a pointer-type digital clock applying a clock brightness control circuit according to the present invention. In this embodiment, the clock brightness control circuit 100 shown in FIG. 1 and FIG. 2 can be used to control light emitting diodes or other light sources disposed on the dial plate of the pointer-type digital clock.

The above-disclosed subject matter is to be considered illustrative, and not restrictive, and it will be apparent to those with ordinary skill in the art that various revisions and modifications are included in the present inventive concept, insofar as they do not depart from the spirit and scope of the present inventive concept. In accordance, the embodiments disclosed in the present inventive concept are intended to describe and not to restrict the technical scope of the present inventive concept, and therefore, the technical scope of the present inventive concept shall not be interpreted as being restricted in any way by the foregoing embodiments. Thus, to the maximum extent allowed by law, the scope of the present inventive concept is to be determined by the broadest permissible interpretation of the following claims and their equivalents, and shall not be restricted or limited by the foregoing detailed description.

What is claimed is:

1. A clock brightness control circuit, the circuit comprising:
a current limiting element;
a current regulating element; and
at least one photosensitive element, connected with the current limiting element and the current regulating element,
wherein the current limiting element and the current regulating element are connected with a light-emitting element of a clock and adjust a current flowing through the light-emitting element under control of the photosensitive element in response to ambient light illumination.

2. The clock brightness control circuit of claim 1, wherein the photosensitive element is a photosensor comprising an element having a viable resistance in response to the ambient light illumination.

3. The clock brightness control circuit of claim 2, wherein the photosensor includes a photosensitive resistor or a photosensitive diode.

4. The clock brightness control circuit of claim 1, wherein the current limiting element includes a first resistor and a second resistor connected in series with the first resistor, and having a first end connected with the first resistor at a first node and a second end connected with the light-emitting element at a second node.

5. The clock brightness control circuit of claim 4, wherein the current regulating element includes a transistor having a base, a collector and an emitter, the collector is connected with the first node, the emitter is connected with the second node, and the photosensitive element is connected between the collector and the base.

6. The clock brightness control circuit of claim 5, wherein the photosensitive element includes a photosensitive resistor and a third resistor connect in series with the photosensitive resistor.

7. The clock brightness control circuit of claim 1, wherein the light-emitting element includes a light-emitting diode.

8. A clock brightness control circuit for adjusting a current flowing through a light-emitting element of a clock, comprising:
a first resistor;
a second resistor, connected in series with the first resistor, and having a first end connected with the first resistor at a first node and a second end connected with the light-emitting element at a second node;
a transistor having a base, a collector and an emitter, wherein the collector is connected with the first node, the emitter is connected with the second node, and
a photosensitive element, connected between the collector and the base.

9. The clock brightness control circuit of claim 8, wherein the photosensitive element includes a photosensitive resistor and a third resistor connected in series with the photosensitive resistor.
